(19) United States
(12) Patent Application Publication
(10) Pub. No.: US 2023/0151258 A1
(43) Pub. Date: May 18, 2023

(54) Thermally Conductive Composite and Method of Making the Same

(71) Applicants: AAC Technologies (Nanjing) Co., Ltd., Nanjing (CN); AAC ACOUSTIC TECHNOLOGIES (SHENZHEN) CO., LTD., Shenzhen (CN)

(72) Inventors: Keqiang Xia, Shenzhen (CN); Bo Zhang, Shenzhen (CN)

(21) Appl. No.: 17/565,329

(22) Filed: Dec. 29, 2021

(30) Foreign Application Priority Data
Nov. 16, 2021 (CN) 202111354868.8

(51) Int. Cl. C09K 5/06; C09J 7/29

(52) U.S. Cl. CPC C09K 5/063; C09J 7/29; C09J 2301/162; C09J 2301/314; C09J 2400/123; C09J 2400/163; C09J 2409/006; C09J 2467/006

(57) ABSTRACT

The present disclosure discloses a thermally conductive composite including a thermally conductive film, having a thickness in a range from 10 um to 50 um, and a thermal phase-change layer disposed on the thermally conductive film, being composed of 6-13 wt% binder, 6-13 wt% thermal phase-change material, and 74-88 wt% coated microcapsule. The thermally conductive composite has dual functions of heat storage and thermal conduction.

### FIELD OF THE PRESENT DISCLOSURE

The present disclosure relates to material technologies, especially relates to a thermally conductive composite and method of making the same.

### DESCRIPTION OF RELATED ART

With development of integration technologies and microelectronics package technologies, the power density of the electronic components improves. However, the package size of the electronic components and devices tends to miniaturization, thus resulting in heat accumulation and heat flux increase around the integrated electronic components. Therefore, the electronic components and devices would gradually degenerate at elevated temperature. A more effectively thermal control solution is expected.

Generally speaking, the heat radiation path is successively heat source, thermally conductive grease, copper plate or graphite plate, heat pipe or uniform temperature board, heat radiation fin or middle frame or back cover. The heat source could be CPU or GPU in the devices. In this way, the heat radiation path is too cumbersome to be effective.

Therefore, it is necessary to provide an improved thermally conductive composite to overcome the problems mentioned above.

### SUMMARY OF THE INVENTION

One aspect of the present disclosure provides a thermally conductive composite with dual functions of heat storage and thermal conduction.

The thermally conductive composite includes a thermally conductive film, having a thickness in a range from 10 um to 50 um, and a thermal phase-change layer disposed on the thermally conductive film, being composed of 6-13 wt% binder, 6-13 wt% thermal phase-change material, and 74-88 wt% coated microcapsule.

Further, the thermally conductive film is chosen from flaky graphite, graphene film, carbon nanotube film, copper foil, thermally conductive PET film, and thermally conductive PI film.

Further, the binder is an elastic random copolymer, an elastic graft copolymer, or an elastic block copolymer.

Further, the binder is chosen from styrene butadiene resin, hydroxyl modified styrene butadiene resin, acrylic resin, waterborne polyurethane, waterborne acrylic resin emulsion, and combinations thereof.

Further, the thermal phase-change material has a thermal transition temperature in a range from 25° C. to 65° C., and is formed from a chain alkane having a chemical formula CnH(n+2); n is in a range from 10 to 44.

Further, the coated microcapsule is an organic phase-change microcapsule having a core-shell structure and having a particle size in a range from 50 um to 500 um.

Further, the organic phase-change microcapsule has a capsule core and a capsule shell; the capsule core includes at least one of paraffin wax, n-octadecane, and n-tetradecane; the capsule shell includes at least one of silica and melamine.

Further, the thermally conductive composite includes a double-sided adhesion layer disposed on one side of the thermal phase-change layer away from the thermally conductive film; the double-sided adhesion layer includes a PET/PI intermediate layer and two glue layers separately arranged on two opposite sides of the PET/PI intermediate layer.

Another aspect of the present disclosure provides a method of manufacturing the thermally conductive composite.

The method includes the steps of: mixing 5-10 wt% binder, 5-10 wt% thermal phase-change material, and 65-70 wt% coated microcapsule into an organic solvent to obtain a mixture sample; coating the mixture sample on the thermally conductive film and removing the organic solvent by heating to obtain the thermally conductive composite.

Further, the organic solvent is at least one of toluene, xylene, butanone, and acetone.

### BRIEF DESCRIPTION OF THE DRAWINGS

The present disclosure will hereinafter be described in detail with reference to an exemplary embodiment. To make the technical problems to be solved, technical solutions and beneficial effects of present disclosure more apparent, the present disclosure is described in further detail together with the figures and the embodiment. It should be understood the specific embodiment described hereby is only to explain this disclosure, not intended to limit this disclosure.

FIG. 1 is a schematic diagram of a thermally conductive composite in accordance with an exemplary embodiment of the present disclosure.

FIG. 2 is a preparation process of the thermally conductive composite in FIG. 1.

FIG. 3 is a preparation process of a mixture sample in FIG. 2.

### DETAILED DESCRIPTION OF THE EXEMPLARY EMBODIMENTS

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

It should be noted that the description of “first”, “second” and the like in the present disclosure is only used for description purposes, and cannot be understood as indicating or implying its relative importance or implying the number of indicated technical features. Thus, a feature defined as “first” or “second” may include at least one such feature, either explicitly or implicitly. In addition, the technical solutions among the various embodiments can be combined with each other, but it must be based on that it can be realized by ordinary technicians. When the combination of the technical solutions is contradictory or cannot be realized, it should be considered that the combination of the technical solutions does not exist, nor is it within the scope of protection required by the present disclosure.

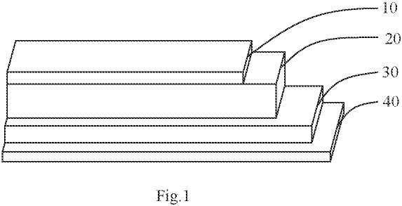

Please refer to FIG. 1, the thermally conductive composite includes a thermally conductive film 10 and a thermal phase-change layer 20 disposed on the thermally conductive film 10. Additionally, the thermally conductive composite further includes a double-sided adhesion layer 30 and a release film 40 both disposed on one side of the thermal phase-change layer 20 away from the thermally conductive film 10.

Specifically, the thermally conductive film has a thickness in a range from 10 um to 50 um. It can be understood that the thickness of the thermally conductive film 10 can be adjusted according to a thickness of the thermally conductive composite. The thermal phase-change layer 20 is composed of 6-13 wt% binder, 6-13 wt% thermal phase-change material, and 74-88 wt% coated microcapsule. It can be understood that um represents micron.

In the present disclosure, a mixture composed of thermal phase-change material and coated microcapsule is coated on the thermally conductive film 10. In the manner, the thermally conductive composite has dual functions of heat storage and thermal conduction, which can effectively solve the overheating and heat radiation issues of the electronic components.

The thermally conductive film 10 can obstruct the air and vapor, simultaneously being highly thermal conductive. For example. The thermally conductive film 10 is chosen from flaky graphite, graphene film, carbon nanotube film, copper foil, thermally conductive polyethylene glycol terephthalate (PET) film, and thermally conductive polyimide (PI) film.

In one embodiment, the binder is an elastic random copolymer, an elastic graft copolymer, or an elastic block copolymer. More specifically, the binder could be chosen from styrene butadiene resin, hydroxyl modified styrene butadiene resin, acrylic resin, waterborne polyurethane, waterborne acrylic resin emulsion, and combinations thereof.

The thermal phase-change material has a thermal transition temperature in a range from 25° C. to 65° C. Further, the thermal phase-change material is formed from a chain alkane having a chemical formula CnH(n+2); n is in a range from 10 to 44. A melting point of organic alkane depends on n, which represents a number of the carbon atom. In one embodiment, n is chosen from the group of 15-40, 18-35 and 18-28. The chain alkane is one type of alkane or a mixture of different types of alkanes. The chain alkane is chosen from n-tetradecane, n-hexadecane, n-heptadecane, n-octadecane, n-eicosane, and combinations thereof.

In one embodiment, the coated microcapsule has a particle size in a range from 50 um to 500 um. Specifically, the coated microcapsule is an organic phase-change microcapsule has a core-shell structure with a capsule core and a capsule shell coated around the capsule core. The capsule core includes at least one of paraffin wax, n-octadecane, and n-tetradecane. The thermal transition temperature of the thermal phase-change material varies with the composition of the capsule core. It could be 35° C., 40° C., 42° C., or 45° C. The capsule shell includes at least one of silica and melamine.

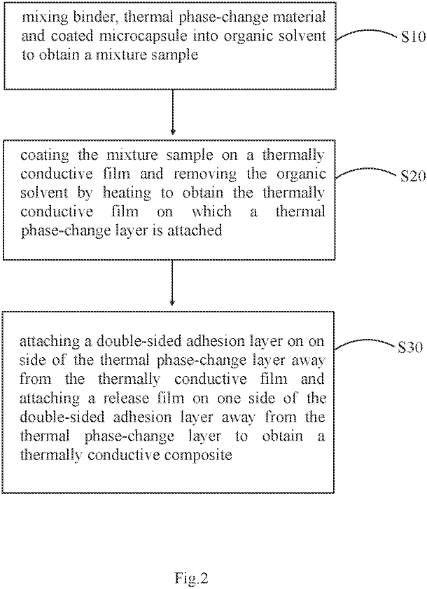

Please refer to FIG. 2, another aspect of the present disclosure is provided a method of manufacturing the thermally conductive composite. The method includes the following steps:
Step 10: mixing 5-10 wt% binder, 5-10 wt% thermal phase-change material, and 65-70 wt% coated microcapsule into an organic solvent to obtain a mixture sample.
Step 20: coating the mixture sample on the thermally conductive film and removing the organic solvent by heating to obtain the thermally conductive film on which the thermally phase-change layer is attached.

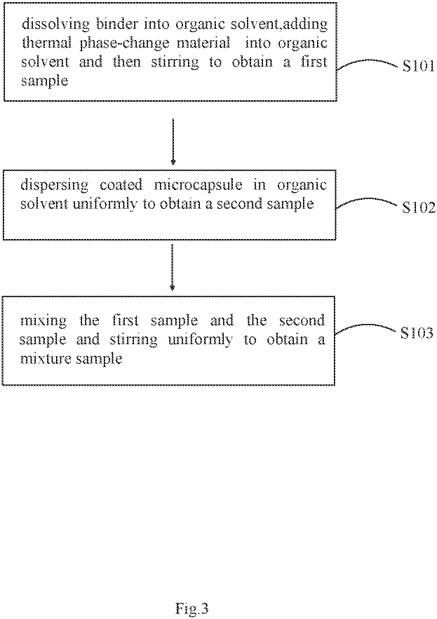

Furthermore, for thermally conductive composite including the double sided adhesion layer 30 and the release film 40, the method further includes Step 30: attaching the double-sided adhesion layer 30 on one side of the thermal phase-change layer 20 away from the thermally conductive film 10, and attaching the release film 40 on one side of the double-sided adhesion layer 30 away from the thermal phase-change layer 20 to obtain the thermally conductive composite. In one embodiment, as shown in FIG. 3, the step 10 further includes three steps as follow.
Step 101: dissolving the binder into the organic solvent; adding the thermal phase-change material into the organic solvent and stirring uniformly to obtain a first sample.
Step 102: dispersing the coated microcapsule into the organic solvent uniformly to obtain a second sample.
Step 103: mixing the first sample with the second sample and then stirring to obtain the mixture sample.

In the present disclosure, the organic solvent serves as a reagent to dissolve the organic compound. The organic solvent is chosen from toluene, xylene, butanone, and combinations thereof. Preparing the first sample and the second sample by separate steps before mixing them can effectively improve the dispersion uniformity.

In the present disclosure, the coating procedure of the mixture sample is finished by a coating device. Specifically, a blade gap of the coating device is set as 500 um to obtain the mixture sample having a thickness of 500 um. Moreover, put the thermally conductive film with the mixture sample into a heater; set the temperature of the heater in a range of 80° C.-100° C. to remove the organic solvent due to its volatility. After the heating procedure of the mixture sample, the thermal phase-change layer is formed on the thermally conductive film.

In some embodiments, the double-sided adhesion layer 30 includes a PET/PI intermediate layer with a thickness of 10 um, and two glue layers with a thickness of 10 um separately arranged on two opposite sides of the PET/PI intermediate layer.

In the present disclosure, the thermally conductive has dual functions of heat storage and thermal conduction, thus solving the overheating and heat radiation issues. Moreover, the thermally conductive composite can be cut into different shapes corresponding to different shape of electronic devices. Here are some embodiments of the present disclosure.

### Embodiment 1

(1) dissolve the 5 wt% styrene butadiene resin into 10 wt% toluene solvent; add 5 wt% n-eicosane into the toluene solvent and stir uniformly to obtain a first sample.

(2) disperse 70 wt% coated microcapsule having the thermal transition temperature of 42° C. into 10 wt% toluene solvent uniformly by means of ultrasonic dispersion or emulsification to obtain a second sample.

(3) mix the first sample with the second sample and then stir them for 30 mins to obtain a mixture sample; set a blade gap a coating device as 500 um and coat the mixture sample on a flaky graphite film with a thickness of 20 um; heat the flaky graphite film with the mixture sample in the heater by setting the temperature as 100° C. to obtain a thermally conductive film attached with a thermal phase-change layer; the thermal phase-change layer includes 6 wt% styrene butadiene resin, 6 wt% n-eicosane and 88 wt% coated microcapsule.

(4) attach a double-sided adhesion layer with a thickness of 30 um on one side of the thermal phase-change layer away from the flaky graphite film, and attach a release film on one side of the double-sided adhesion layer away from the thermal phase-change layer to obtain a thermally conductive composite.

(5) cut the thermally conductive composite as required.

### Embodiment 2

(1) dissolve the 10 wt% styrene butadiene resin into 5 wt% toluene solvent; add 5 wt% n-eicosane into the toluene solvent and stir uniformly to obtain a first sample.

(2) disperse 65 wt% coated microcapsule having the thermal transition temperature of 42° C. into 10 wt% toluene solvent uniformly by means of ultrasonic dispersion or emulsification to obtain a second sample.

(3) mix the first sample with the second sample and then stir them for 30 mins to obtain a mixture sample; set a blade gap a coating device as 500 um and coat the mixture sample on a flaky graphite film with a thickness of 20 um; heat the flaky graphite film with the mixture sample in the heater by setting the temperature as 100° C. to obtain a thermally conductive film attached with a thermal phase-change layer; the thermal phase-change layer includes 12 wt% styrene butadiene resin, 6 wt% n-eicosane and 82 wt% coated microcapsule.

(4) attach a double-sided adhesion layer with a thickness of 30 um on one side of the thermal phase-change layer away from the flaky graphite film, and attach a release film on one side of the double-sided adhesion layer away from the thermal phase-change layer to obtain a thermally conductive composite.

(5) cut the thermally conductive composite as required.

### Embodiment 3

(1) dissolve the 7 wt% styrene butadiene resin into 8 wt% toluene solvent; add 8 wt% n-eicosane into the toluene solvent and stir uniformly to obtain a first sample.

(2) disperse 67 wt% coated microcapsule having the thermal transition temperature of 42° C. into 10 wt% toluene solvent uniformly by means of ultrasonic dispersion or emulsification to obtain a second sample.

(3) mix the first sample with the second sample and then stir them for 30 mins to obtain a mixture sample; set a blade gap a coating device as 500 um and coat the mixture sample on a flaky graphite film with a thickness of 20 um; heat the flaky graphite film with the mixture sample in the heater by setting the temperature as 80° C. to obtain a thermally conductive film attached with a thermal phase-change layer; the thermal phase-change layer includes 8 wt% styrene butadiene resin, 10 wt% n-eicosane and 82 wt% coated microcapsule.

(4) attach a double-sided adhesion layer with a thickness of 30 um on one side of the thermal phase-change layer away from the flaky graphite film, and attach a release film on one side of the double-sided adhesion layer away from the thermal phase-change layer to obtain a thermally conductive composite.

(5) cut the thermally conductive composite as required.

### Embodiment 4

(1) dissolve the 5 wt% styrene butadiene resin into 10 wt% toluene solvent; add 10 wt% n-eicosane into the toluene solvent and stir uniformly to obtain a first sample.

(2) disperse 65 wt% coated microcapsule having the thermal transition temperature of 35° C. into 10 wt% toluene solvent uniformly by means of ultrasonic dispersion or emulsification to obtain a second sample.

(3) mix the first sample with the second sample and then stir them for 30 mins to obtain a mixture sample; set a blade gap a coating device as 500 um and coat the mixture sample on a flaky graphite film with a thickness of 20 um; heat the flaky graphite film with the mixture sample in the heater by setting the temperature as 110° C. to obtain a thermally conductive film attached with a thermal phase-change layer; the thermal phase-change layer includes 6 wt% styrene butadiene resin, 12 wt% n-eicosane and 82 wt% coated microcapsule.

(4) attach a double-sided adhesion layer with a thickness of 30 um on one side of the thermal phase-change layer away from the flaky graphite film, and attach a release film on one side of the double-sided adhesion layer away from the thermal phase-change layer to obtain a thermally conductive composite.

(5) cut the thermally conductive composite as required.

### Embodiment 5

(1) dissolve the 5 wt% styrene butadiene resin into 10 wt% toluene solvent; add 5 wt% n-eicosane into the toluene solvent and stir uniformly to obtain a first sample.

(2) disperse 70 wt% coated microcapsule having the thermal transition temperature of 42° C. into 10 wt% toluene solvent uniformly by means of ultrasonic dispersion or emulsification to obtain a second sample.

(3) mix the first sample with the second sample and then stir them for 30 min to obtain a mixture sample; set a blade gap a coating device as 500 um and coat the mixture sample on a flaky graphite film with a thickness of 20 um; heat the flaky graphite film with the mixture sample in the heater by setting the temperature as 110° C. to obtain a thermally conductive film attached with a thermal phase-change layer; the thermal phase-change layer includes 6 wt% styrene butadiene resin, 6 wt% n-eicosane and 88 wt% coated microcapsule.

(4) attach a double-sided adhesion layer with a thickness of 30 um on one side of the thermal phase-change layer away from the flaky graphite film, and attach a release film on one side of the double-sided adhesion layer away from the thermal phase-change layer to obtain a thermally conductive composite.

(5) cut the thermally conductive composite as required.

### Embodiment 6

(1) dissolve the 5 wt% styrene butadiene resin into 10 wt% toluene solvent; add 5 wt% n-eicosane into the toluene solvent and stir uniformly to obtain a first sample.

(2) disperse 70 wt% coated microcapsule having the thermal transition temperature of 42° C. into 10 wt% toluene solvent uniformly by means of ultrasonic dispersion or emulsification to obtain a second sample.

(3) mix the first sample with the second sample and then stir them for 30 mins to obtain a mixture sample; set a blade gap a coating device as 500 um and coat the mixture sample on a copper foil with a thickness of 35 um; heat the flaky graphite film with the mixture sample in the heater by setting the temperature as 80° C. to obtain a thermally conductive film attached with a thermal phase-change layer; the thermal phase-change layer includes 6 wt% styrene butadiene resin, 6 wt% n-eicosane and 88 wt% coated microcapsule.

(4) attach a double-sided adhesion layer with a thickness of 30 um on one side of the thermal phase-change layer away from the flaky graphite film, and attach a release film on one side of the double-sided adhesion layer away from the thermal phase-change layer to obtain a thermally conductive composite.

(5) cut the thermally conductive composite as required.

### Embodiment 7

(1) dissolve the 5 wt% styrene butadiene resin into 10 wt% toluene solvent; add 5 wt% n-eicosane into the toluene solvent and stir uniformly to obtain a first sample.

(2) disperse 70 wt% coated microcapsule having the thermal transition temperature of 42° C. into 10 wt% toluene solvent uniformly by means of ultrasonic dispersion or emulsification to obtain a second sample.

(3) mix the first sample with the second sample and then stir them for 30 mins to obtain a mixture sample; set a blade gap a coating device as 500 um and coat the mixture sample on a PET film with a thickness of 15 um; heat the flaky graphite film with the mixture sample in the heater by setting the temperature as 110° C. to obtain a thermally conductive film attached with a thermal phase-change layer; the thermal phase-change layer includes 6 wt% styrene butadiene resin, 6 wt% n-eicosane and 88 wt% coated microcapsule.

(4) attach a double-sided adhesion layer with a thickness of 30 um on one side of the thermal phase-change layer away from the flaky graphite film, and attach a release film on one side of the double-sided adhesion layer away from the thermal phase-change layer to obtain a thermally conductive composite.

(5) cut the thermally conductive composite as required.

In the embodiments above, the styrene butadiene resin serves as binder, the toluene serves as organic solvent and the n-eicosane serves as thermal phase-change material. It can be understood that other row material can be chosen only if satisfy the conditions above. Properties of the thermally conductive composites in the embodiments above are shown in the chart table below.

TABLE 1

| | Embodiment 1 | Embodiment 2 | Embodiment 3 | Embodiment 4 | Embodiment 5 | Embodiment 6 | Embodiment 7 |
|---|---|---|---|---|---|---|---|
| styrene butadiene resin | 5 | 10 | 7 | 5 | 5 | 5 | 5 |
| n-eicosane | 5 | 5 | 8 | 10 | 5 | 5 | 5 |
| Coated microcapsule with a thermal transition temperature of 42° C. | 70 | 65 | 67 | 65 | 70 | 70 | 70 |
| Blade gap (um) | 500 | 500 | 500 | 500 | 1000 | 500 | 500 |
| Thermally conductive film | Flaky graphite | Flaky graphite | Flaky graphite | Flaky graphite | Flaky graphite | Copper foil | PET |
| Thickness (mm) | 0.3±0.03 | 0.3±0.03 | 0.3±0.03 | 0.3±0.03 | 0.5 8±0.05 | 0.32±0.03 | 0.30±0.03 |
| Density (kg/m³) | 812 | 810 | 801 | 795 | 798 | 1220 | 770 |
| Enthalpy (J/g) | 155 | 145 | 153 | 161 | 205 | 121 | 165 |
| Thermal transition temperature (°C) | 42 | 41 | 40 | 39 | 43 | 41 | 44 |
| Enthalpy loss after double 85 | <10 % | <10 % | <10 % | <10 % | <10 % | <10 % | <10 % |
| Thermal conductivity (w/m·k) | 0.43 | 0.38 | 0.33 | 0.34 | 0.31 | 0.45 | 0.14 |

In table 1, the enthalpy represents the heat absorption ability or heat radiation ability of the thermal conductive composite. The higher the enthalpy, the stronger the heat absorption capacity, which cause better thermal control effect. The thermal transition temperature represents the temperature when the thermally conductive composite starts to absorb or release heat. The enthalpy loss after double 85 refers to enthalpy loss ratio after 300 hours under high temperature and high humidity. The thermal conductivity represents the heat conduction ability of the thermally conductive composite.

As shown in table 1, in the embodiments 1-3, as the key property of the thermally conductive composite, the enthalpy reduces with increase of the styrene butadiene resin served as binder. But it is not beneficial to the film forming performance of the thermally conductive composite if the binder content is too low. In the embodiments 1 and 4, the enthalpy increases with increase of the n-eicosane served as thermal phase-change material. But the forming performance of the thermally conductive composite may decline when reducing the content of the coated microcapsule. In the embodiments 1 and 5, the enthalpy increases with increase of the thickness of the thermal phase-change layer. Therefore, the thickness of the thermally conductive composite can be adjusted corresponding to the enthalpy demand. In the embodiments 1-5 and embodiments 6-7, diverse thermally conductive films may change the enthalpy, thermal conductivity and thermal transition temperature of the thermally conductive composite.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

1. A thermally conductive composite comprising:
a thermally conductive film, having a thickness in a range from 10 um to 50 um; and
a thermal phase-change layer disposed on the thermally conductive film, being composed of 6-13 wt% binder, 6-13 wt% thermal phase-change material, and 74-88 wt% coated microcapsule.

2. The thermally conductive composite as described in claim 1, wherein the thermally conductive film is chosen from flaky graphite, graphene film, carbon nanotube film, copper foil, thermally conductive PET film, and thermally conductive PI film.

3. The thermally conductive composite as described in claim 1, wherein the binder is an elastic random copolymer, an elastic graft copolymer, or an elastic block copolymer.

4. The thermally conductive composite as described in claim 3, wherein the binder is chosen from styrene butadiene resin, hydroxyl modified styrene butadiene resin, acrylic resin, waterborne polyurethane, waterborne acrylic resin emulsion, and combinations thereof.

5. The thermally conductive composite as described in claim 1, wherein the thermal phase-change material has a thermal transition temperature in a range from 25° C. to 65° C., and is formed from a chain alkane having a chemical formula CnH(n+2); n is in a range from 10 to 44.

6. The thermally conductive composite as described in claim 1, wherein the coated microcapsule is an organic phase-change microcapsule having a core-shell structure and having a particle size in a range from 50 um to 500 um.

7. The thermally conductive composite as described in claim 6, wherein the organic phase-change microcapsule has a capsule core and a capsule shell; the capsule core includes at least one of paraffin wax, n-octadecane, and n-tetradecane; the capsule shell includes at least one of silica and melamine.

8. The thermally conductive composite as described in claim 1, further comprising a double-sided adhesion layer disposed on one side of the thermal phase-change layer away from the thermally conductive film; the double-sided adhesion layer comprises a PET/PI intermediate layer and two glue layers separately arranged on two opposite sides of the PET/PI intermediate layer.

9. A method of manufacturing the thermally conductive composite as described in claim 1, comprising the steps of:
mixing 5-10 wt% binder, 5-10 wt% thermal phase-change material, and 65-70 wt% coated microcapsule into an organic solvent to obtain a mixture sample; coating the mixture sample on the thermally conductive film and removing the organic solvent by heating to obtain the thermally conductive composite.

10. The method as described in claim 9, wherein the organic solvent is at least one of toluene, xylene, butanone, and acetone.
